(19) United States
(12) Patent Application Publication
(10) Pub. No.: US 2012/0114867 A1
(43) Pub. Date: May 10, 2012

(54) Method and device for rimming glasses

(76) Inventor: Peter Quinn, (US)

(21) Appl. No.: 12/941,107

(22) Filed: Nov. 8, 2010

(51) Int. Cl. B05D 1/18; B05C 3/00

(52) U.S. Cl. 427/430.1; 118/428

(57) ABSTRACT

A glass rimming device and method which permits bartenders to produce more types of drinks, more efficiently. A drawer compartment, holding food trays, is attached by a set of guide rails to the underside of a bar counter. When the glass rimming device is in the closed position the food trays are kept hidden out of the way. When the bartender is ready to rim glasses they use one hand to pull the drawer compartment out, and the other hand dips the glass into the food trays. When finished the bartender just pushes the drawer compartment back under the bar, thereby saving time by using a cleaner glass rimming method that only takes up unused space.

### BACKGROUND OF THE INVENTION

The present invention generally relates to an improved glass rimming device and method which permits bartenders to produce more types of drinks more efficiently. The current three level glass rimmer consists of three shallow plastic discs or plates which can be filled with salt, sugar, and lime juice. The glass is pressed into the rimmer upside down in the lime juice to moisten the rim for the application of salt or sugar. Each plate folds over the one below. To open the rimmer you most slide the cover aside and then unfold the separate plates to reveal the condiments. The present invention, known as the Margarita Mate, has the options to have six flavored rimmers, rather then three. The present invention also is more sturdy then the tri-level rimmer, the salt, and other ingredients do not drip over into the hinges.

There are four main drawbacks of the current method. The first drawback of the current glass rimmer is that it can only be opened using both hands. When making drinks the bartender must put down the shakers and glasses to open the glass rimmer which can add a lot of time over a busy shift. The second drawback is that the lime juice and salt can, and often do, get into the hinge mechanism of the rimmer making it hard to keep clean. The third drawback is that the current method takes up valuable space on the top of the bar. The fourth drawback is that the current method only has the option of three flavors whereas the present invention provides up to six different flavors.

### SUMMARY OF THE INVENTION

Applicant's present invention is related to producing more types of cocktail drinks more efficiently by providing many more options to rim the glass with in a much streamlined fashion. In one preferred embodiment the present invention comprises a drawer situated underneath a bar counter, that slides out to reveal three dishes with different ingredients used to rim cocktail glasses, it would be made of stainless steel, and it would have a cover that springs up when the drawer is pulled out to serve as advertising space and a shield for the food items. The present invention can be used without the top spring lid with advertising. The present invention can be utilized as small as three flavored rimmers and as large as six flavored rimmers. The present invention allows the bartender to produce multi-flavored drinks with multi-flavored rimmers with one hand. The process only requires the bartender to use one hand to pull out the rimmers, while holding the glass. The current method requires two hands to open the rimmers then after the glass is rimmed it requires to be closed with two hands.

The present invention is more useful and efficient then the current method in regards to sanitation, time, and space. The present invention is cleaner then the current version as it is made from stainless stain and can be washed and dried in the restaurant's dishwashers to be sanitized. The current method is made from plastic and needs to be washed by hand. The present invention is more time efficient as it only requires bartenders to use one hand to open the drawer and the other hand can hold the glass, rather than the current version which requires both hands to open the glass rimmer and both hands to close the glass rimmer. The present invention is more space efficient as it enables the bartenders to have six ingredients in one area, rather than the current methods which store fewer types of items in smaller amounts.

The purpose of the present invention is to provide bartenders and waitstaff a faster, more productive way of producing detailed multi-ingredient drinks The present invention provides the ability to rim margarita glasses and martini glasses with such ingredients as sugar, salt, caramel, graham cracker, nuts, and chocolate (flavored rimmers). The primary purpose of the present invention is to rim drink glasses. The present invention could also be utilized for ice cream toppings in a restaurant. The present invention will strictly function the same way although the ingredient cylinders would be closed, providing the waitstaff a shaped, flat, dipping surface. Therefore the topping ingredient would not drop on the floor, or into other ingredients as the waitstaff are covering the ice-cream cone with the toppings. The present invention would also be able to be utilized with one hand by pulling out the tray from under the counter, while the waitstaff are able to hold the cone with the other hand.

The present invention is safer because the extra toppings are not falling on the floor providing a slippery surface for waitstaff to walk upon. The present invention is also more sanitary as the extra toppings that fall off the cone are not dropped in other ingredients. After the cone is dipped in the other toppings the cone can be directly given to the customer. The present invention is also more efficient in providing the toppings for the ice-cream cone. The current method is for the waitstaff to spoon over the toppings on the cone, which causes the toppings to fall off and does not equally cover the entire cone.

### DESCRIPTION OF THE DRAWINGS

FIG. 1 shows the Margarita Mate in the open position with the cover (3) in the up position. The cover (3) is hingedly secured to the drawer compartment (2). An effective amount of food trays (5) are in the drawer compartment (2). A set of guide rails (4) connect the drawer compartment (2) to the outer sleeve (1).

### DETAILED DESCRIPTION OF THE INVENTION

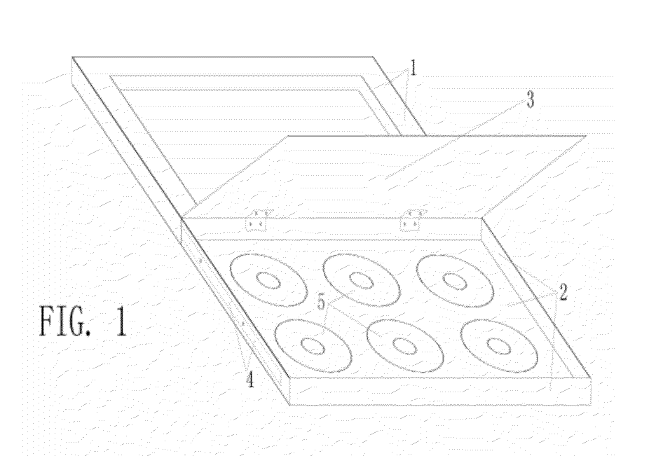

Referring now to FIG. 1, the preferred embodiment of the invention has essentially a conventional drawer apparatus modified only as described below. There are many different sizes, shapes, and designs for such conventional drawer systems and the embodiment of this invention contemplates use of these various types of cases. The prior art did not teach of any way for increasing bar top space, maximizing the time efficiencies of one handed operation, or providing for a device that would be easier to clean. The prior art is flawed because: it is time consuming to stop work to open the container; it is hard to keep clean as it is constantly being moved which can result in lime juice pouring into the hinge of the device, each time it needs to be cleaned it has to be dissassembled; it takes up a lot of valuable counter space which in most bars and restaurants is limited; and it is limited to three flavors. Whereas, the present invention solves these problems by: saving time due to the ability to open the drawer with a single hand; it can be removed and placed in a commercial dishwasher due to its construction of stainless steel, or hosed off for ease of cleaning; it is located under the bar counter in an area of unused space; and by providing more flavored choices, up to six.

The prior art did not teach a means to access the food trays by sliding them out like a drawer. The drawer compartment (2) of the rimming device slides out from the underside of the bar to expose the food items inside. A set of guide rails (4) are attached to the drawer compartment (2) and allow for the sliding motion. In a preferred embodiment the guide rails (4) are affixed to a sleeve which is then affixed to the underside of the bar, but the invention could have the guide rails (4) connect directly to the underside of the bar. The dimensions of the drawer compartment (2) are optimized to fit under the bar so as to provide for maximum efficient space usage. In a preferred embodiment the drawer compartment (2) is hinged to a cover (3) that is spring loaded, which allows the cover to open from a tighter seal with the drawer compartment in the closed position.

The prior art did not teach a system that uses more than three food trays. The drawer compartment (2) of the rimming device has an effective amount of food trays (5) flexibly attached. A preferred embodiment has three food trays, but the invention could accommodate up to six food trays for additional food items, and even more depending on how much unused space is taken up by extra levels of drawers or the width and depth of available space. The food trays (5) should be appropriately sized for mating with conventional sized glasses.

The prior art did not teach a system that is made of stainless steel and easily cleanable with the type of cleaning equipment in a conventional restaurant. The drawer compartment (2) is removable from the underside of the bar for cleaning purposes. A preferred embodiment of the present invention is constructed of stainless steel and also has removable food trays, all allowing for easy cleanup.

The prior art did not teach a system that keeps the rimming device out of the way and off the bar-top to maximize space, for quick efficient usage, and an uncluttered appearance. The drawer compartment (2) is located underneath the bar-top. The present invention stays out of the way until it is needed by attaching the drawer compartment (2) to a set of guide rails (4) and then to either a sleeve (1) or directly to the underside of the bar. A preferred embodiment has only one level of drawer compartment (2), but the invention could have multiple levels of drawer compartments. Those additional levels may be attached by any conventional means that one of skill in the art would use.

What is claimed is:

1. A beverage rimming device comprising a drawer apparatus affixed to the underside of a bar counter having a drawer compartment with five largely planar walls comprising:
(a) a larger bottom wall which is parallel to the bar counter upon which it is affixed, and it is perpendicular to each of four other side walls;
(b) an effective amount of round food trays, largely planar and flexibly attached in a parallel fashion to said bottom wall of said compartment to allow for their removal and cleaning, with walls to keep food items inside, appropriately sized radii to allow for conventionally sized glasses rim's to sit within, and to apply a coating of food items on said rims by dipping them into the food items resting in the food trays; and
(c) a set of guide rails that are affixed to the outside of two opposing side walls of the compartment, and affixed to the underside of the bar counter to allow for the compartment to slide in and out from under the bar counter.

2. The beverage rimming device according to claim 1 wherein the drawer components are formed from stainless steel to provide for durability and ease of cleaning.

3. The beverage rimming device according to claim 1 further comprising a cover that is attached to the rear of the drawer, thereby providing a better seal when said drawer is in the closed position, and is hingedly spring loaded to raise said cover from being initially parallel to the plane of the bottom wall, with a set of decorative stickers for advertising purposes, affixed to an outside wall located directly on the other side of the surface of the inside wall of the cover that faces said bottom wall.

4. The beverage rimming device according to claim 1 wherein the effective amount of circularly shaped food trays are not planar, but have a circular trough of such radius as to maximize usage of said food items and to roughly mate with a conventionally sized glass for more efficient use of time and materials.

5. The beverage rimming device according to claim 1 further comprising a multitude of tiered drawers wherein an additional set of guide rails are affixed between the existing drawer compartment and an additional drawer compartment situated directly underneath the original drawer compartment, thereby providing additional levels of food trays for the purpose of achieving a larger amount of food trays in less length of bar.

6. The beverage rimming device according to claim 1 wherein the guide rails which are affixed to the drawer compartment are affixed first to a sleeve that receives the drawer compartment and which is itself affixed directly to the underside of the bar counter.

7. A method for rimming glasses with food items comprising the steps of:
providing a drawer apparatus affixed to the underside of a bar counter with numerous food trays separately filled with liquid and dry food items;
inverting the glass down onto food tray filled with liquid food items to bring the rim of the glass into contact with the liquid food item in said food tray to wet said rim;
and thereafter, inverting the glass into a food tray filled with dry food items to bring the rim of the glass into contact with dry food items to coat said rim.
